(19) United States
(12) Patent Application Publication
(10) Pub. No.: US 2023/0075402 A1
(43) Pub. Date: Mar. 9, 2023

(54) COMMUNICATION SYSTEM, SERVER AND STORAGE MEDIUM STORING PROGRAM

(71) Applicant: LINE Corporation, Tokyo (JP)

(72) Inventors: Sengpei LIEW, Tokyo (JP); Tsubasa TAKAHASHI, Tokyo (JP)

(73) Assignee: LINE Corporation, Tokyo (JP)

(21) Appl. No.: 17/941,349

(22) Filed: Sep. 9, 2022

(30) Foreign Application Priority Data
Sep. 9, 2021 (JP) 2021-146642

(51) Int. Cl. H04L 9/08

(52) U.S. Cl. CPC H04L 9/0825; H04L 9/0891; H04L 2209/12

(57) ABSTRACT

A communication system includes a server and a plurality of terminals. The server manages a public key and a private key. Each terminal includes computing circuitry that adds noise to first target data stored in the terminal, encrypts the first target data, to which the noise is added, using the public key, randomly chooses and determines, out of the server and different terminals, a first transmission destination of the first target data, transmits the encrypted first target data to the determined first transmission destination, receives second target data from a different terminal, randomly chooses and determines, out of the server and the different terminals, a second transmission destination of the received second target data, and transmits the received second target data to the second determined transmission destination. The server receives target data transmitted from the terminals and decrypt the received target data using the private key.

### CROSS-REFERENCE TO RELATED APPLICATION

The present application claims priority under 35 U.S.C. § 119 to Japanese Patent Application No. 2021-146642, filed Sep. 9, 2021, the contents of which application are incorporated herein by reference in their entirety.

### BACKGROUND

### Technical Field

The present disclosure relates to a communication systems and/or a non-transitory computer readable storage medium having stored therein a program.

### Background

As a technology for analyzing collected data while achieving privacy protection by inhibiting information on an individual included in the collected data from being disclosed to anyone other than the individual, some different privacy protection techniques known. such different privacy protection techniques enhance privacy protection by adding statistical noise to data and randomizing the data at a data collection source or shuffling and interchanging the data to anonymize the data collection source. Combination of noise to be given at a data collection source and data shuffling, in particular, makes it possible to reduce necessary noise while ensuring data indistinguishability in a device which collects data.

### SUMMARY

At least some example embodiments of the present disclosure provide a communication system and/or a non-transitory computer readable storage medium having stored therein a program that when executed by a processor, is capable of ensuring anonymity of collected data while keeping noise to be given at a data collection source small and of collecting data while achieving a balance between improvement of utility as statistical data and enhancement of privacy protection.

According to an example embodiment of the present disclosure, there is provided a communication system including a server and a plurality of terminals. The server includes first processing circuitry that is configured to manage a public key and a private key, with which information encrypted using the public key is decrypted. The plurality of terminals include a terminal and different terminals, and the terminal include a memory configured to store first target data, and second processing circuitry configured to add noise to the first target data stored in the memory, encrypt the first target data, to which the noise has been added, using the public key, randomly choose and determine, out of the server and the different terminals, a first transmission destination of the first target data stored in the memory, transmit the encrypted first target data to the determined first transmission destination, receive second target data transmitted from one of the different terminals, randomly choose and determine, out of the server and the different terminals, a second transmission destination of the received second target data, and transmit the received second target data to the determined second transmission destination. The server is further configured to receive third target data from the terminals, and decrypt the received third target data using the private key.

According to an example embodiment of the present disclosure, there is provided a server capable of communicating with a plurality of terminals. The server includes first processing circuitry that is configured to manage a public key and a private key, with which information encrypted using the public key is decrypted. The plurality of terminals include a terminal and different terminals, and the terminal include a memory configured to store first target data, and second processing circuitry configured to add noise to the first target data stored in the memory, encrypt the first target data, to which the noise has been added, using the public key, randomly choose and determine, out of the server and the different terminals, a first transmission destination of the first target data stored in the memory, transmit the encrypted first target data to the determined first transmission destination, receive second target data transmitted from one of the different terminals, randomly choose and determine, out of the server and the different terminals, a second transmission destination of the received second target data, and transmit the received second target data to the determined second transmission destination. The server is further configured to receive third target data from the terminals, and decrypt the received third target data using the private key.

According to an example embodiment of the present disclosure, a non-transitory computer-readable storage medium having stored thereon a program which when executed by a terminal in a communication system including a server and a plurality of terminals, the terminal being one of the plurality of terminals, causes the terminal to add noise to first target data stored in a memory of the terminal, encrypt the first target data, to which the noise has been added, using a public key managed by the server, randomly choose and determine, out of the server and one or more different the terminals which are other than the terminal, a first transmission destination of the first target data stored in the memory of the terminal, transmit the encrypted first target data to the determined first transmission destination, receive second target data transmitted from a different terminal other than the terminal, randomly choose and determine, out of the server and the one or more different terminals other than the terminal, a second transmission destination of the received second target data, and transmit the received second target data to the determined second transmission destination.

The communication system, a server and a non-transitory computer readable storage medium having stored therein the program according to the present disclosure have the effect of ensuring anonymity of collected data while keeping noise to be given at a data collection source small and of collecting data while achieving a balance between improvement of utility as statistical data and enhancement of privacy protection.

### BRIEF DESCRIPTION OF DRAWINGS

FIG. 1 is a diagram showing an overall configuration of a communication system, according to an example embodiment.

FIG. 2 is a block diagram showing a configuration of a server included in the communication system of FIG. 1, according to an example embodiment.

FIG. 3 is a block diagram showing a configuration of a terminal included in the communication system of FIG. 1, according to an example embodiment.

FIG. 4 is a chart for explaining an example of a process in the terminal of FIG. 3, according to an example embodiment.

FIG. 5 is a diagram for explaining an example of a process in the communication system of FIG. 1, according to an example embodiment.

FIG. 6 is a chart for explaining a modified example of a process in the communication system of FIG. 1, according to an example embodiment.

FIG. 7 is chart for explaining an example of a case of choosing and determining a transmission destination of target data out of adjacent terminals in the communication system of FIG. 1, according to an example embodiment.

FIG. 8 is chart for explaining another example of a case of choosing and determining a transmission destination of target data out of adjacent terminals in the communication system of FIG. 1, according to an example embodiment.

FIG. 9 is chart for explaining still another example of a case of choosing and determining a transmission destination of target data out of adjacent terminals in the communication system.

### DETAILED DESCRIPTION

Modes for implementing a communication system, a server and a non-transitory computer readable storage medium having stored therein a program according to the present disclosure will be described with reference to the accompanying drawings. The same or corresponding portions are denoted by the same reference numerals in the drawings, and a redundant description thereof will be properly simplified or omitted. In the following description, a positional relationship between structures may be depicted on the basis of an illustrated state for the sake of convenience. Note that the present disclosure is not limited to the example embodiments below and that it is possible to freely combine the disclosed example embodiments, deform an arbitrary component in each example embodiment, or omit an arbitrary component in each example embodiment without departing from the spirit of the present disclosure.

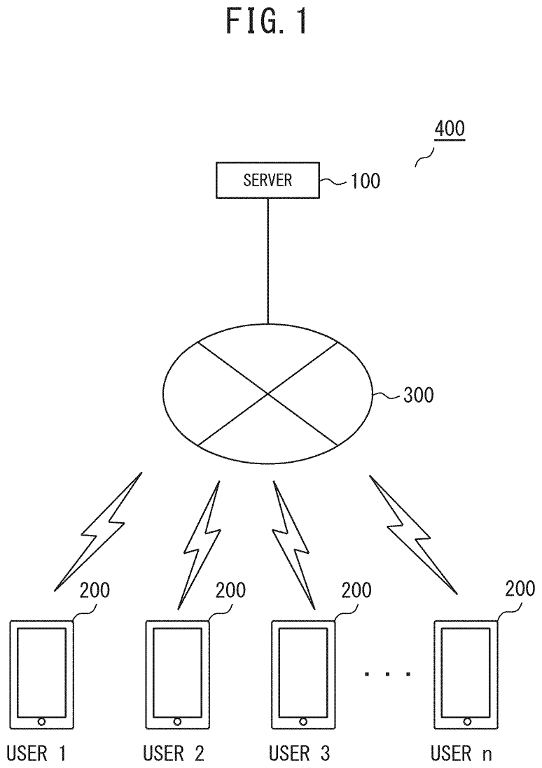

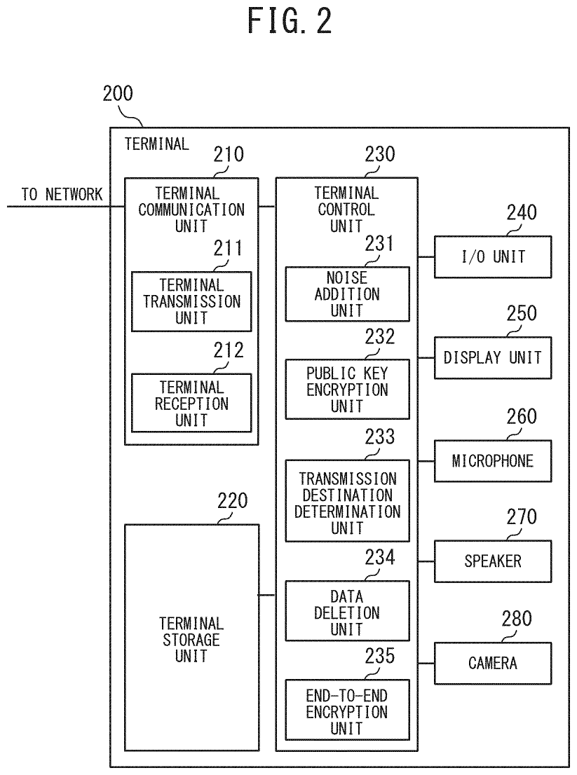

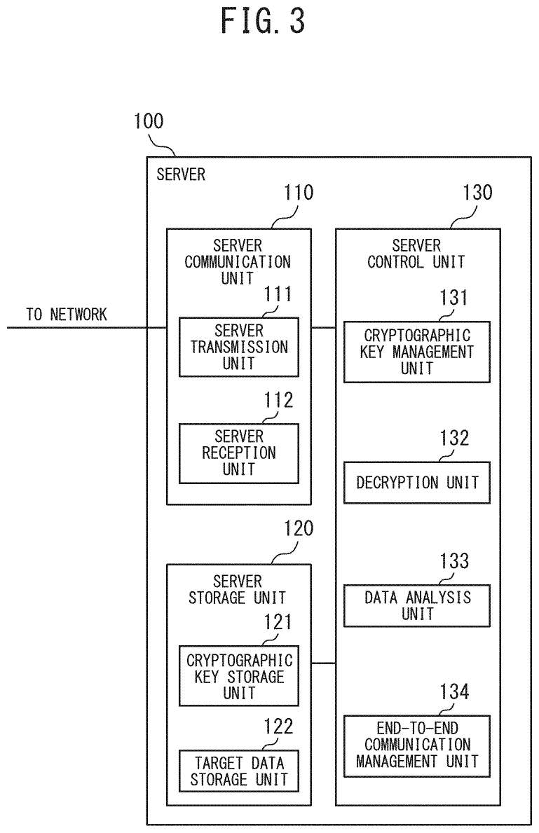

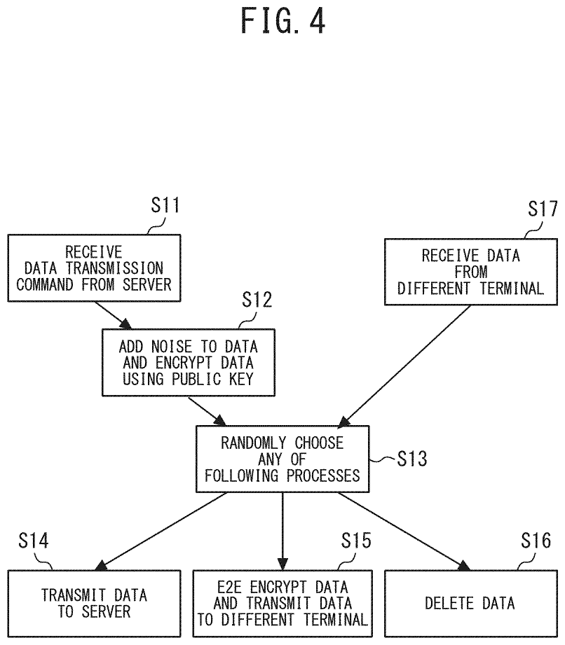

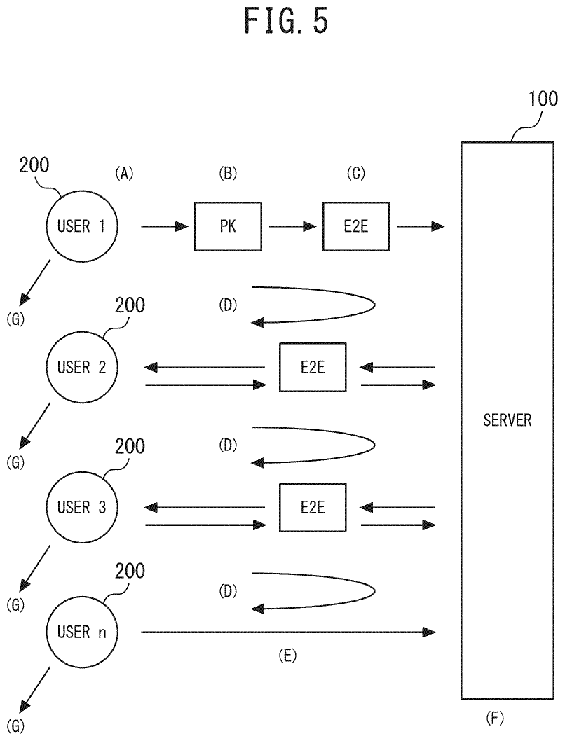

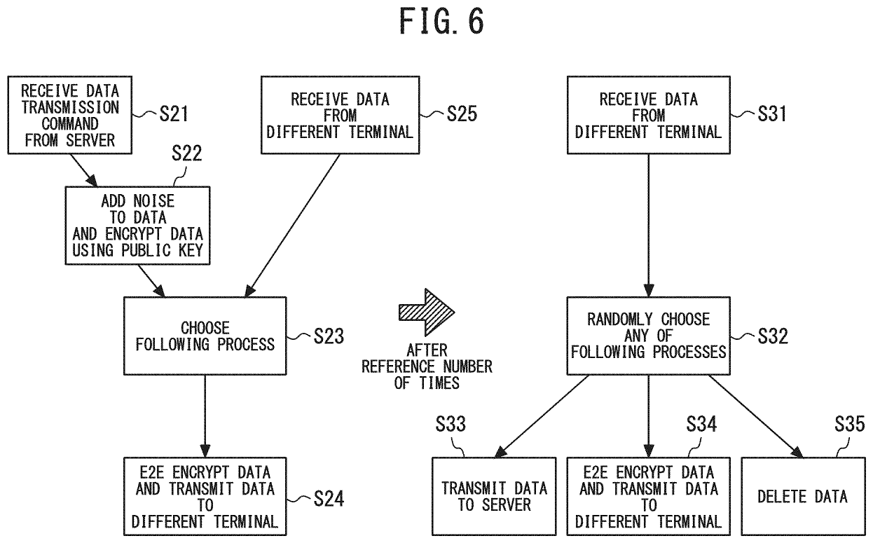

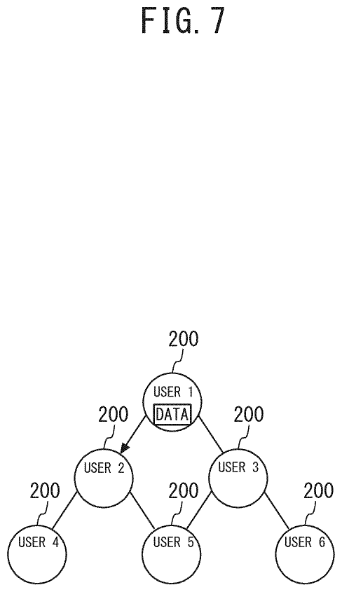

Some example embodiments of the present disclosure will be described with reference to FIGS. 1 to 9. FIG. 1 is a diagram showing an overall configuration of a communication system, according to an example embodiment. FIG. 2 is a block diagram showing a configuration of a server included in the communication system, according to an example embodiment. FIG. 3 is a block diagram showing a configuration of a terminal included in the communication system, according to an example embodiment. FIG. 4 is a chart for explaining an example of a process in the terminal of FIG. 3, according to an example embodiment. FIG. 5 is a diagram for explaining an example of a process in the communication system of FIG. 1, according to an example embodiment. FIG. 6 is a chart for explaining a modified example of a process in the communication system of FIG. 1, according to an example embodiment. FIGS. 7 to 9 are example charts for explaining cases of choosing and determining a transmission destination of target data out of adjacent terminals in the communication system.

As shown in FIG. 1, a communication system 400 according to an example embodiment includes a server 100 and terminals 200. In the communication system 400, the server 100 and the terminals 200 are communicably connected via a network 300. The communication system 400 includes n terminals 200. Here, n is an integer not less than 2. The server 100 is intended to collect data stored in the terminals 200 owned by users via the network 300. In the description of the present disclosure, data serving as an object to be collected by the server 100 is called “target data.” Information on an individual user which is an owner of the terminal 200 storing target data can be included in the target data. The server 100 is intended to analyze the collected target data while inhibiting information on an individual included in the target data from being disclosed to anyone other than the individual (e.g., achieving privacy protection and to obtain a statistical nature and feature of the target data).

The network 300 plays a role in connecting one or more terminals 200 and one or more servers 100. That is, the network 300 means a communication network which provides a connection path such that the terminal 200 can transmit and receive data after the terminal 200 connects to the server 100. Each of one or a plurality of portions of the network 300 may be a wired network or a wireless network.

The network 300 can include, for example, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of the public switched telephone network (PSTN), a mobile telephone network, ISDN (Integrated Services Digital Network), LTE (Long Term Evolution), CDMA (Code Division Multiple Access), Bluetooth®, or satellite communication, or a combination of two or more thereof. The network 300 can include one or a plurality of networks.

Any terminal may be adopted as the terminal 200 as long as the terminal is an information terminal which can implement functions of the present disclosure. The terminal 200 includes, for example, a smartphone, a mobile phone (feature phone), a computer (e.g., a desktop PC, a laptop PC, or a tablet PC), a media computer platform (e.g., a cable, a satellite set-top box, or a digital video recorder), a handheld computer device (e.g., a PDA (Personal Digital Assistant) or an e-mail client), a wearable terminal (e.g., an eyeglass-type device or a wristwatch-type device), a different type of computer, or a communication platform. The terminal 200 may be depicted as an information processing terminal.

The server 100 has a function of providing a desired (or alternatively, predetermined) service to the terminal 200. The server 100 may or may not have a function of providing a messaging service which allows content transmission and reception between the terminals 200 in addition to the aforementioned function of collecting target data.

Any device may be adopted as the server 100 as long as the device is an information processing device which can implement the functions of the present disclosure. The server 100 includes, for example, a server device, a computer (e.g., a desktop PC, a laptop PC, or a tablet PC), a media computer platform (e.g., a cable, a satellite set-top box, or a digital video recorder), a handheld computer device (e.g., a PDA or an e-mail client), a different type of computer, or a communication platform. The server 100 may be depicted as an information processing device. If there is no need to make a distinction between the server 100 and the terminal 200, the server 100 and the terminal 200 may be commonly depicted as an information processing device.

Configurations of the terminals 200 are basically the same. The configuration of the terminal 200 will be described with reference to FIG. 2. The terminal 200 includes a terminal control unit 230, a terminal storage unit 220, a terminal communication unit 210, an I/O unit 240, a display unit 250, a microphone 260, a speaker 270, and a camera 280. Components of hardware of the terminal 200 are connected to one another, for example, via a bus. Note that it is not essential for the terminal 200 to include all components described here in terms of hardware configuration. For example, the terminal 200 may have a configuration in which one or more individual components, such as the microphone 260, the camera 280, or a plurality of components are removed.

The terminal control unit 230 has a circuit which is physically structured to execute a function to be implemented by codes or commands included in a program and is implemented by, for example, a data processing device which is built into hardware. Thus, the terminal control unit 230 may or may not be depicted as a control circuit (e.g., processing circuitry).

The terminal control unit 230 includes, for example, a central processing unit (CPU), a microprocessor, a processor core, a multiprocessor, an ASIC (Application-Specific Integrated Circuit), or an FPGA (Field Programmable Gate Array).

The terminal storage unit 220 has a function of storing various types of programs and various types of data needed for the terminal 200 to operate. The terminal storage unit 220 includes, for example, various types of storage media, such as an HDD (Hard Disk Drive), an SSD (Solid State Drive), a flash memory, a RAM (Random Access Memory), or a ROM (Read Only Memory). The terminal storage unit 220 may be depicted as a memory.

The terminal 200 stores a program in the terminal storage unit 220 and executes the program. This causes the terminal control unit 230 to execute processes as units included in the terminal control unit 230. That is, the program stored in the terminal storage unit 220 causes the terminal 200 to implement functions to be executed by the terminal control unit 230. In other words, a processor executes the program stored in the memory in the terminal 200, and the hardware and software of the terminal 200 collaborate, thereby implementing functions of the units that the terminal 200 includes. Note that the program may be depicted as a program module.

The terminal communication unit 210 transmits and receives various types of data via the network 300. Communication concerned with the transmission and reception may be executed either by wire or by wireless. Any communication protocol may be adopted as long as intercommunication is executable. The terminal communication unit 210 has a function of executing communication with the server 100 via the network 300. The terminal communication unit 210 includes a terminal transmission unit 211 and a terminal reception unit 212. The terminal transmission unit 211 transmits various types of data to the server 100 in accordance with instructions from the terminal control unit 230. The terminal reception unit 212 receives various types of data transmitted from the server 100 and conveys the various types of data to the terminal control unit 230. The terminal communication unit 210 may be depicted as a terminal communication I/F (interface). If the terminal communication unit 210 is composed of a physically structured circuit, the terminal communication unit 210 may be depicted as a terminal communication circuit.

The I/O unit 240 includes an input unit and an output unit. The input unit is a device with which various types of manipulations on the terminal 200 are input. The output unit is a device which outputs a processing result of processing in the terminal 200. In the I/O unit 240, the input unit and the output unit may be integral, or may be separated into the input unit and the output unit.

The input unit is implemented by any type of device that can accept an input from a user and convey information related to the input to the terminal control unit 230, or a combination thereof. The input unit includes, for example, a touch panel, a touch display, hardware keys (e.g., a keyboard), a pointing device (e.g., a mouse), a camera configured to receive a manipulative input through a moving image, or a microphone configured to receive a manipulative input by voice.

The output unit is implemented by any type of device that can output a processing result of processing in the terminal control unit 230, or a combination thereof. The output unit includes, for example, a touch panel, a touch display, a speaker configured to output a voice output, a lens configured to output, for example, a three dimensional (3D) output or a hologram output, or a printer.

The display unit 250 is implemented by any type of device that can produce a display in accordance with display data written in a frame buffer. The display unit 250 includes, for example, a touch panel, a touch display, a monitor (e.g., a liquid crystal display (LCD) or an Organic Electroluminescence Display (OELD)), a head mounted display (HMD), projection mapping, a hologram, or any device which can display an image, text information, and the like in an air-containing space or the like (which may be a vacuum). Note that the display unit 250 may be capable of displaying display data in 3D.

The terminal control unit 230 has a function of controlling display on the display unit 250. The terminal control unit 230 generates display data related to a display screen to be displayed by the display unit 250. The terminal control unit 230 performs a process of causing the display unit 250 to display the generated display data. That is, the terminal control unit 230 has a function of converting display data into pixel information and writing the pixel information in the frame buffer of the display unit 250.

Note that, if the I/O unit 240 has a touch panel, the I/O unit 240 and the display unit 250 may be arranged so as to face each other and may have the same sizes and shapes.

The microphone 260 is used to input voice data. The speaker 270 is used to output voice data. The camera 280 is used to obtain moving image data and/or still image data.

A configuration of the server 100 will be described with reference to FIG. 3. The server 100 includes a server control unit 130, a server storage unit 120, and a server communication unit 110. Components of hardware of the server 100 are connected to one another via, for example, a bus.

The server control unit 130 has a circuit (e.g., processing circuitry) which is physically structured to execute a function to be implemented by codes or commands included in a program and is implemented by, for example, a data processing device which is built into hardware. The server control unit 130 may be a central processing unit (CPU). The several control unit 130 may include, for example, a microprocessor, a processor core, a multiprocessor, an ASIC, an FPGA, or the like. In the present disclosure, the server control unit 130 is not limited to these.

The server storage unit 120 has a function of storing various types of programs and various types of data needed for the server 100 to operate. The server storage unit 120 is implemented by any type of storage medium. The server storage unit 120 may include, for example, an HDD, an SSD, or a flash memory. Note that the server storage unit 120 is not limited to these. The server storage unit 120 may be depicted as a memory.

The server communication unit 110 transmits and receives various types of data via the network 300. Communication concerned with the transmission and reception may be executed either by wire or by wireless. Any communication protocol may be adopted as long as intercommunication is executable. The server communication unit 110 has a function of executing communication with the terminal 200 via the network 300. The server communication unit 110 includes a server transmission unit 111 and a server reception unit 112. The server transmission unit 111 transmits various types of data to the terminal 200 in accordance with instructions from the server control unit 130. The server communication unit 110 receives various types of data transmitted from the terminal 200 and conveys the various types of data to the server control unit 130. The server communication unit 110 may be depicted as a server communication I/F (interface). If the server communication unit 110 is composed of a physically structured circuit, the server communication unit 110 may be depicted as a server communication circuit.

Note that the server 100 may include an I/O unit (not shown) and a display (not shown) in terms of hardware configuration. The I/O unit is implemented by a device with which various types of manipulations on the server 100 are input. The I/O unit is implemented by any type of device that can accept an input from a user and convey information related to the input to the server control unit 130. The display may be implemented by a monitor (e.g., an LCD or an OELD). In this case, the hardware of the server 100 may have a configuration in which the display removed.

The server 100 stores a program in the server storage unit 120 and executes the program. This causes the server control unit 130 to execute processes as units included in the server control unit 130. That is, the program stored in the server storage unit 120 causes the server 100 to implement functions to be executed by the server control unit 130. In other words, a processor executes the program stored in the memory in the server 100, and the hardware and software of the server 100 collaborate, thereby implementing functions of the units that the server 100 includes. Note that the program may be depicted as a program module.

Note that the terminal control unit 230 of the terminal 200 and/or the server control unit 130 of the server 100 may implement processes by means of not only a CPU having a control circuit but also a logical circuit (hardware) or a dedicated circuit formed in an integrated circuit (IC) chip, an LSI (Large Scale Integration), or the like. These circuits may each be implemented by one or a plurality of integrated circuits. A plurality of processes illustrated in the present disclosure may be implemented by one integrated circuit. An LSI may be called a VLSI, a super LSI, an ultra LSI, or the like depending on the degree of integration.

A program (e.g., a software program, a computer program, or a program module) of the present disclosure may be provided in a state of being stored in a computer-readable storage medium. As for the storage medium, a program can be stored in a non-transitory tangible medium. The program may be intended to implement some of the functions in the embodiment of the present disclosure. Additionally, the program may be one which can implement the functions of the present disclosure by being combined with a program already recorded on a storage medium (e.g., a so-called differential file (differential program)).

The storage medium can include one or a plurality of semiconductor-based circuits or different integrated circuits (IC) (e.g., a field programmable gate array (FPGA) or an application-specific integrated circuit (ASIC)), a hard disk drive (HDD), a hybrid hard drive (HHD), an optical disk, an optical disk drive (ODD), a magneto-optical disk, a magneto-optical drive, a floppy disk, a floppy disk drive (FDD), a magnetic tape, a solid state drive (SSD), a RAM drive, a Secure Digital Card, a drive, an arbitrary different appropriate storage medium, or an appropriate combination of two or more thereof. The storage medium may be volatile, non-volatile, or a combination of volatility and non-volatility if appropriate. Note that the storage medium is not limited to these examples and that any device or medium may be adopted as long as the storage medium can store a program. The storage medium may be depicted as a memory.

A program of the present disclosure may or may not be provided to the server 100 and/or the terminal 200 via an arbitrary transmission medium (e.g., a communication network or broadcast waves) which is capable of transmitting the program. If the program is provided via a transmission medium, the server 100 and/or the terminal 200 can implement functions of a plurality of functional units illustrated in each example embodiment by, for example, executing a program downloaded via, for example, the Internet.

The example embodiments of the present disclosure can be implemented even if the program is in the form of data signals embedded in a carrier wave which are embodied by electronic transmission. At least some of processes in the server 100 and/or the terminal 200 may be implemented by cloud computing composed of one or more computers. At least some of processes in the terminal 200 may be performed by the server 100. In this case, at least some processes of processes by functional units of the terminal control unit 230 of the terminal 200 may be performed by the server 100. At least some of processes in the server 100 may be performed by the terminal 200. In this case, at least some processes of processes by functional units of the server control unit 130 of the server 100 may be performed by the terminal 200.

The program of the present disclosure can be implemented using, for example, a script language (e.g., ActionScript or JavaScript®), an object-oriented programming language (e.g., Objective-C or Java®), or a markup language (e.g., HTML5).

As shown in FIG. 3, the server storage unit 120 of the server 100 includes a cryptographic key storage unit 121. Information on a public key and a private key is stored in the cryptographic key storage unit 121. The public key is intended to encrypt information. The private key is intended to decrypt information encrypted using the public key. The server 100 has a cryptographic key management unit 131 as a function to be implemented by the server control unit 130. The public key and the private key are paired. For example, the public key is generated from the paired private key. The cryptographic key management unit 131 manages the public key and the private key as the pair. The public key is opened at least to the terminal 200 that communicates with the server 100 under management by the cryptographic key management unit 131. In contrast, the private key is kept secret.

In the communication system 400 according to the present disclosure, the terminal storage unit 220 of each terminal 200 is a storage unit which stores target data. For example, the terminal storage unit 220 stores user information of an owner of the terminal 200, information on a usage history, setup information of the terminal 200, the details of an answer to a particular question or questionnaire input by the user, and the like. User information includes, for example, information associated with the user, such as a name of the user, an icon image of the user, an age of the user, a gender of the user, an address of the user, likes and tastes of the user, and an identifier of the user, which is input by the user. Some or all of the user information, the information on the usage history, the setup information, and the details of the answer of the user can be target data.

As shown in FIG. 2, each terminal 200 has a noise addition unit 231, a public key encryption unit 232, and a transmission destination determination unit 233 as functions to be implemented by the terminal control unit 230. The noise addition unit 231 adds noise to target data stored in the terminal storage unit 220 of the terminal 200. The noise addition unit 231 adds noise to target data by a desired (or alternatively, predetermined) statistical manipulation.

An example of noise addition by the noise addition unit 231 will be described. Assume in this example that target data is binary data which has two possible values. Examples of binary data include a biological gender (male or female), an answer (yes or no), and presence or absence (present or absent). Assume here that target data has a value of 0 or 1. The noise addition unit 231 reverses a value of target data with a preset probability p (0<p<1). That is, if a true value of target data is 0, a value of the target data after noise addition is 1 with the probability p and is 0 with a probability (1-p). If the true value of the target value is 1, the value of the target data after noise addition is 0 with the probability p and is 1 with the probability (1-p).

The public key encryption unit 232 is an encryption unit which encrypts target data, to which noise is added by the noise addition unit 231, using a public key. A public key used for encryption is managed by the cryptographic key management unit 131 of the server 100. In communication between the server 100 and the terminal 200, the server transmission unit 111 transmits a public key to the terminal 200. The terminal reception unit 212 receives the public key transmitted from the server 100. The public key encryption unit 232 uses the public key thus obtained to encrypt target data, to which noise is added.

The transmission destination determination unit 233 randomly chooses out of the server 100 and the different terminals 200 other than the terminal 200 and determines a transmission destination of target data stored in the terminal storage unit 220 of the terminal 200. In the following description, the different terminal 200 other than the terminal 200 will be simply referred to as a different terminal 200. Letting p1 be the probability that each of the different terminals 200 is determined to be the transmission destination; and p2, the probability that the server 100 is determined to be the transmission destination, p1 and p2 are set or preset so as to satisfy the following expressions (1) to (3).

p1×(n−1)+p2=1 (1)

0<p1<1 (2)

0<p2<1 (3)

The terminal transmission unit 211 transmits target data encrypted by the public key encryption unit 232 to a transmission destination determined by the transmission destination determination unit 233. That is, the terminal transmission unit 211 transmits the target data encrypted by the public key encryption unit 232 to one of the different terminals 200 or the server 100.

If a transmission destination is determined to be the terminal 200 by the transmission destination determination unit 233 of any one of the different terminals 200, encrypted target data is transmitted from the different terminal 200 to the terminal 200. The terminal reception unit 212 receives the target data transmitted from the different terminal 200 to the terminal 200. If the terminal reception unit 212 of the terminal 200 receives target data transmitted from the different terminal 200, the transmission destination determination unit 233 of the terminal 200 further randomly chooses out of the server 100 and the different terminals 200 other than the terminal 200 and determines a transmission destination of the target data received by the terminal reception unit 212 of the terminal 200. The terminal transmission unit 211 of the terminal 200 transmits the target data received by the terminal reception unit 212 of the terminal 200 to the transmission destination determined by the transmission destination determination unit 233 of the terminal 200.

The server reception unit 112 of the server 100 receives encrypted pieces of target data transmitted from the respective terminals 200. As shown in FIG. 2, in the communication system 400 according to this example embodiment, the server 100 includes a decryption unit 132 and a data analysis unit 133 as functions to be implemented by the server control unit 130. The server storage unit 120 further includes a target data storage unit 122. The decryption unit 132 decrypts target data received by the server reception unit 112 using the private key. The private key used for decryption is managed by the cryptographic key management unit 131. The target data storage unit 122 stores and accumulates target data decrypted by the decryption unit 132.

The data analysis unit 133 statistically processes and analyzes target data stored in the target data storage unit 122, obtains a nature, a feature, and the like of the whole target data, and outputs an analysis result. Note that statistical processing of target data by the data analysis unit 133 is performed with additional consideration of details of the desired (or alternatively, predetermined) statistical manipulation performed at the time of noise addition by the noise addition unit 231 of each terminal 200. The server transmission unit 111 outputs an analysis result to a designated output destination.

In the communication system 400 according to the present disclosure, each terminal 200 may delete one or both of target data stored in the terminal storage unit 220 of the terminal 200 and target data received by the terminal reception unit 212 with a desired (or alternatively, preset) probability. For example, each terminal 200 further includes a data deletion unit 234 as a function to be implemented by the terminal control unit 230 and the data deletion unit 234 deletes one or both of target data stored in the terminal storage unit 220 and target data received by the terminal reception unit 212 with the desired (or alternatively, preset) probability.

The data deletion unit 234 deletes target data stored in the terminal storage unit 220 and/or target data received by the terminal reception unit 212 with a probability p3. If target data is not deleted, a transmission destination of the target data is determined by the transmission destination determination unit 233. That is, the aforementioned probabilities p1 and p2 and the probability p3 are set or preset so as to satisfy the aforementioned expressions (2) and (3) and the expressions (1′) and (4) below.

p1×(n−1)+p2+p3=1 (1′)

0<p3<1 (4)

Note that communication of target data between the terminals 200 may be performed via the server 100 and be end-to-end encrypted. If communication of target data between the terminals 200 is performed via the server 100 and is end-to-end encrypted, each terminal 200 further includes an end-to-end encryption unit 235 as a function to be implemented by the terminal control unit 230, as shown in FIG. 2. As shown in FIG. 3, the server 100 further includes an end-to-end communication management unit 134 as a function to be implemented by the server control unit 130.

If a transmission destination of target data is determined to be the different terminal 200 by the transmission destination determination unit 233, communication of the target data between the terminals 200 is performed via the server 100. At this time, the communication between the terminals 200 via the server 100 is managed by the end-to-end communication management unit 134 of the server 100. At the time of transmission of target data from a given terminal 200 to another terminal 200, the target data is subjected to end-to-end encryption. That is, if a transmission destination of target data is determined to be the different terminal 200 by the transmission destination determination unit 233, the end-to-end encryption unit 235 encrypts the target data.

An example of a process in the terminal 200 in the communication system 400 with the above-described configuration will be described with reference to FIG. 4. When the terminal reception unit 212 receives a data transmission command from the server 100 (operation S11), the terminal control unit 230 performs a process in operation S12. In operation S12, the noise addition unit 231 adds noise to target data stored in the terminal storage unit 220. The public key encryption unit 232 encrypts the target data, to which the noise is added by the noise addition unit 231, using the public key.

In succeeding operation S13, either one of determination of a transmission destination of the target data by the transmission destination determination unit 233 or deletion of the target data by the data deletion unit 234 is chosen, and subsequently any one of processes in operations S14 to S16 is randomly performed. That is, the transmission destination of the target data is determined to be the server 100 with the probability p2 by the transmission destination determination unit 233, and in this case, the terminal transmission unit 211 transmits the target data to the server 100 (operation S14). With the probability p1 for every different terminal 200, the transmission destination of the target data is determined to be the different terminal 200 by the transmission destination determination unit 233, and in this case, the target data is encrypted by the end-to-end encryption unit 235 and is transmitted to the different terminal 200 by the terminal transmission unit 211 (operation S15). The target data is deleted with the probability p3 by the data deletion unit 234 (operation S16).

If the terminal reception unit 212 receives target data transmitted from the different terminal 200 (operation S17), deletion of the target data or determination of a transmission destination is randomly chosen in operation S13. Subsequently, any one of the processes in operations S14 to S16 is randomly performed.

As described above, in the terminal 200 according to this example embodiment, for example, a program to be executed by the terminal 200 of the communication system 400 executes at least the following processes:

adding noise to target data stored in the terminal storage unit 220 of the terminal 200

encrypting the target data, to which the noise is added, using the public key managed by the server 100

randomly choosing and determining out of the server 100 and the different terminals 200 a transmission destination of the target data stored in the terminal storage unit 220 of the terminal 200

transmitting the encrypted target data to the determined transmission destination

receiving target data transmitted from the different terminal 200

randomly choosing and determining out of the server 100 and the different terminals 200 a transmission destination of the received target data

transmitting the received target data to the determined transmission destination

Another example of a process in the whole communication system 400 with the above-described configuration will be described with reference to FIG. 5. In the example shown in FIG. 5, noise is added to target data stored in the terminal storage unit 220 by the noise addition unit 231 in the terminal 200 of user 1 ((A) in FIG. 5). As indicated by (B) in FIG. 5, the target data, to which the noise is added, is encrypted using the public key of the server 100 by the public key encryption unit 232. With this encryption, content of the target data is viewable only on the server 100 having the private key corresponding to the public key, and interception by a device or the like other than the server 100 can be mitigated or prevented.

The target data is transmitted to the different terminal 200 via the server 100 with the probability p1 ((D) in FIG. 5). In the example shown in FIG. 5, the target data is transmitted from the terminal 200 of user 1 to the terminal 200 of user 2, is transmitted from the terminal 200 of user 2 to the terminal 200 of user 3, and is transmitted from the terminal 200 of user 3 to the terminal 200 of user n. At this time, as indicated by (C) in FIG. 5, communication between the terminals 200 is end-to-end encrypted. This makes it possible to mitigate or prevent interception by a third party other than the terminal 200 as a transmission destination.

Target data is transmitted to the server 100 with the probability p2 ((E) in FIG. 5). In the example shown in FIG. 5, the target data of the terminal 200 of user 1 is finally transmitted from the terminal 200 of user n to the server 100. The server 100 can obtain the target data of the terminal 200 of user 1 by decrypting the received data using the private key in the decryption unit 132 ((F) in FIG. 5). As described above, although the content of the target data exchanged between the terminals 200 cannot be viewed on the server 100, it is possible to make the content of the target data finally transmitted to the server 100 to be viewable on the server 100. Note that, as indicated by (G) in FIG. 5, the target data may be deleted with the probability p3 in each terminal 200.

As described above, in the communication system 400 according to this example embodiment, noise is given to target data in each terminal 200, target data is randomly exchanged between the terminals 200, and target data is transmitted from the terminal 200 to the server 100 with a fixed probability. For this reason, the same level of anonymity as that obtained when target data is shuffled can be obtained without the need for a device for shuffling and interchanging target data. It is thus possible to enhance anonymity of data on the side with the server 100 that collects data while keeping noise to be given to target data on the terminal 200 side small and to achieve a balance between improvement of utility as statistical data and enhancement of privacy protection. Because a device for shuffling and interchanging target data is not desired, a risk that a target data set before shuffling may leak can be reduced.

With the provision of the data deletion unit 234, the same effect as in a case where target data to be collected is randomly extracted can be obtained. It is thus possible to achieve further enhancement of privacy protection. Because the number of pieces of target data to be communicated between the terminals 200 decreases, the amount of communicated data is reduced between the terminals 200, and a reduction in a communication load can be achieved. A communication load can be effectively reduced especially by deleting target data stored in the terminal, to which the data deletion unit 234 belongs, with the fixed probability p3 by means of the data deletion unit 234.

End-to-end encryption of communication between the terminals 200 allows mitigation or prevention of interception by a third party other than the terminal 200 as a transmission destination. Because communication of target data between the terminals 200 cannot be viewed even on the server 100, anonymity of data in the server 100 that collects data can be more reliably maintained.

A first modification and a second modification of the communication system 400 according to this example embodiment will be described. In the first modification and the second modification, the transmission destination determination unit 233 randomly chooses out of different terminals and determines a transmission destination of target data stored in the terminal storage unit 220 of the terminal 200. That is, the target data stored in the terminal is not directly sent to the server 100.

For target data received by the terminal reception unit 212 (e.g., target data transmitted from the different terminal 200), candidate transmission destinations change depending on the number of times communication of target data between the terminals 200 has been performed. In the first modification, the transmission destination determination unit 233 randomly chooses out of the different terminals 200 and determines a transmission destination of target data received by the terminal reception unit 212 until communication of target data between the terminals 200 is performed a desired (or alternatively, preset) reference number of times. The transmission destination determination unit 233 determines the transmission destination of the target data received by the terminal reception unit 212 to be the server 100 after communication of the target data between the terminals 200 is performed the aforementioned reference number of times.

The reference number of times for the communication may be determined in accordance with the number of terminals 200 included in the communication system 400. For example, the reference number of times is set not less than a minimum integer which is not less than a natural logarithm ln(n) of the number n of terminals 200 included in the communication system 400.

For example, if communication between the terminals 200 is performed via the server 100, the number of times communication of target data between the terminals 200 has been performed in the communication system 400 can be easily counted by the server 100. Even if communication between the terminals 200 is not performed via the server 100, notification of the number of times each terminal 200 has received target data transmitted from the different terminal 200 to the server 100 allows the server 100 to count the number of communications. The server 100 notifies each terminal 200 of the counted number of times communication of target data between the terminals 200 has been performed or whether the number of times communication of target data between the terminals 200 has been performed is not less than the reference number of times. This allows each terminal 200 to determine a transmission destination in accordance with the number of communications.

As described above, in the first modification, the terminal 200 first transmits target data stored therein to the different terminal 200, and communication of target data between the terminals 200 is repeated without transmission of target data to the server 100 until the number of communications of target data between the terminals 200 is not less than the reference number of times. When the number of communications of target data between the terminals 200 is not less than the reference number of times, each terminal 200 transmits target data to the server 100. With this configuration, target data is exchanged between the terminals 200 a fixed number of times or more, and the same level of anonymity as that obtained when target data is shuffled can be more reliably ensured. The same level of anonymity as that obtained when pieces of target data of all the terminals 200 are collected and shuffled at a time can be obtained especially by setting the reference number of times at the minimum integer that is not less than the natural logarithm ln(n) of the number n of terminals 200 included in the communication system 400.

In the second modification, the transmission destination determination unit 233 randomly chooses out of the different terminals 200 and determines a transmission destination of target data received by the terminal reception unit 212 until communication of target data between the terminals 200 is performed the aforementioned reference number of times, like in the first modification. The transmission destination determination unit 233 chooses out of the server 100 and the different terminals 200 and determines a transmission destination of target data received by the terminal reception unit 212 after communication of target data between the terminals 200 is performed the reference number of times, unlike in the first modification.

As described above, in the second modification, the terminal 200 first transmits target data stored therein to the different terminal 200, and communication of target data between the terminals 200 is repeated without transmission of target data to the server 100 until the number of communications of target data between the terminals 200 reaches a reference number of times. When the number of communications of target data between the terminals 200 is not less than the reference number of times, the terminal 200 transmits target data to the server 100 or the different terminal 200. Even with this configuration, target data is exchanged between the terminals 200 a fixed number of times or more, and the same level of anonymity as that obtained when target data is shuffled can be more reliably ensured, like in the first modification.

Note that, in the first modification and the second modification, each terminal 200 may have the data deletion unit 234. If the terminal 200 has the data deletion unit 234, the data deletion unit 234 may change whether to delete target data, on the basis of the number of times communication of target data between the terminals 200 has been performed. If whether to delete target data is changed on the basis of the number of times communication of target data between the terminals 200 has been performed, for example, the data deletion unit 234 does not delete target data until the number of communications of target data between the terminals 200 reaches the aforementioned reference number of times. After communication of target data between the terminals 200 is performed the reference number of times, the data deletion unit 234 deletes target data received by the terminal reception unit 212 with the aforementioned probability p3.

An example of a process in the terminal 200 according to the second modification with the above-described configuration will be described with reference to FIG. 6. When the terminal reception unit 212 receives a data transmission command from the server 100 (operation S21), the terminal control unit 230 performs a process in operation S22. In operation S22, the noise addition unit 231 adds noise to target data stored in the terminal storage unit 220. The public key encryption unit 232 encrypts the target data, to which the noise is added by the noise addition unit 231, using a public key.

In succeeding operation S23, determination of a transmission destination of the target data by the transmission destination determination unit 233 is chosen, and subsequently a process in operation S24 is performed. In operation S24, the transmission destination of the target data is determined to be the different terminal 200 by the transmission destination determination unit 233. In this case, the target data is encrypted by the end-to-end encryption unit 235 and is transmitted to the different terminal 200 by the terminal transmission unit 211.

If the terminal reception unit 212 receives target data transmitted from the different terminal 200 (operation S25), the processes in operations S23 and S24 are performed until communication of target data between the terminals 200 is performed the aforementioned reference number of times. That is, the target data received by the terminal reception unit 212 is encrypted by the end-to-end encryption unit 235 and is transmitted to the different terminal 200 by the terminal transmission unit 211.

If the terminal reception unit 212 receives target data transmitted from the different terminal 200 (operation S31) after the number of communications of target data between the terminals 200 reaches the reference number of times, either one of determination of a transmission destination of the target data by the transmission destination determination unit 233 or deletion of the target data by the data deletion unit 234 is chosen in succeeding operation S32, and subsequently any one of processes in operations S33 to S35 is randomly performed. That is, the transmission destination of the target data is determined to be the server 100 with a probability p2 by the transmission destination determination unit 233, and in this case, the terminal transmission unit 211 transmits the target data to the server 100 (operation S33). With a probability p1 for every different terminal 200, the transmission destination of the target data is determined to be the different terminal 200 by the transmission destination determination unit 233, and in this case, the target data is encrypted by the end-to-end encryption unit 235 and is transmitted to the different terminal 200 by the terminal transmission unit 211 (operation S34). The target data is deleted with a probability p3 by the data deletion unit 234 (operation S35).

Note that, in the above-described configuration examples, the different terminals 200 that serve as candidate transmission destinations when the transmission destination determination unit 233 randomly determines a transmission destination of target data to be all the terminals 200 other than the terminal 200 (e.g., (n-1) terminals 200), to which the transmission destination determination unit 233 belongs. However, when the transmission destination determination unit 233 randomly determines a transmission destination of target data, the transmission destination determination unit 233 may make all of the (n-1) terminals 200 other than the terminal 200 candidate as transmission destinations or may make only some of the terminals 200 other than the terminal 200 as candidate transmission destinations.

For example, various types of known forms, such as a ring type, a mesh type, a star type, a fully connected type, a bus type, or a tree type, are conceivable as logical topologies for a virtual network having the terminals 200 as nodes. The transmission destination determination unit 233 may determine the different terminals 200 that serve as candidate transmission destinations in accordance with a logical topology of a virtual network having the terminals 200 as nodes. In this case, for example, it is conceivable that the transmission destination determination unit 233 makes the terminals 200 as nodes adjacent to the terminal 200 candidate transmission destinations of target data in the logical topology of the network having the terminals 200 as nodes.

An example of a case of choosing and determining a transmission destination of target data out of the adjacent terminals 200 will be described with reference to FIGS. 7 to 9. In a logical topology in a network shown in FIGS. 7 to 9, the terminal 200 of user 2 and the terminal 200 of user 3 are adjacent to the terminal 200 of user 1. The terminal 200 of user 4 and the terminal 200 of user 5 are adjacent to the terminal 200 of user 2. The terminal 200 of user 5 and the terminal 200 of user 6 are adjacent to the terminal 200 of user 3.

In an initial state shown in FIG. 7 of the above-described network, the transmission destination determination unit 233 of the terminal 200 of user 1 randomly chooses out of the terminal 200 of user 2 and the terminal 200 of user 3 that are adjacent to the terminal 200 of user 1 and determines a transmission destination of target data of the terminal 200 of user 1. In the example shown in FIG. 7, the transmission destination is determined to be the terminal 200 of user 2. The target data of the terminal 200 of user 1 is transmitted to the terminal 200 of user 2.

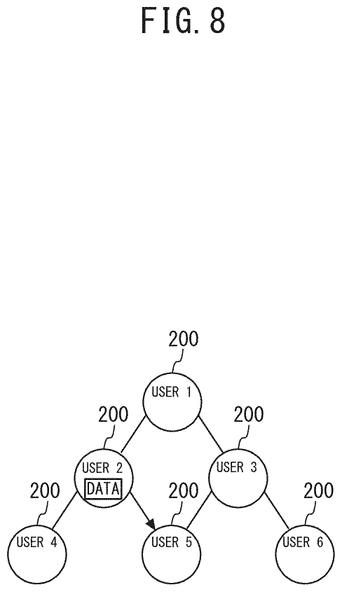

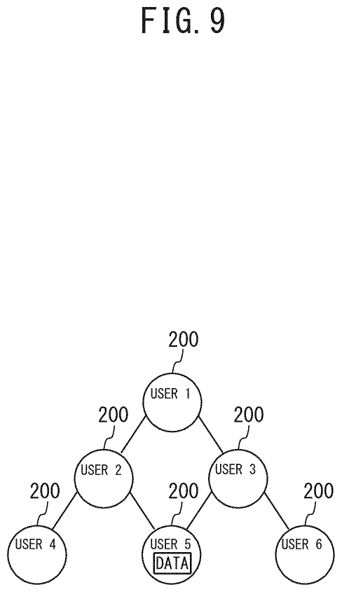

As shown in FIG. 8, the terminal 200 of user 2 receives the target data transmitted from the terminal 200 of user 1. The transmission destination determination unit 233 of the terminal 200 of user 2 randomly chooses determines a transmission destination of the received target data out of the terminal 200 of user 4 and the terminal 200 of user 5 that are adjacent to the terminal 200 of user 2 and. In the example shown in FIG. 8, the transmission destination is determined to the terminal 200 of user 5. The target data is transmitted to the terminal 200 of user 5. As shown in FIG. 9, the terminal 200 of user 5 receives the target data transmitted from the terminal 200 of user 2.

As described above, the transmission destination determination unit 233 randomly chooses out of the terminals 200 as nodes adjacent to the terminal 200, to which the transmission destination determination unit 233 belongs, and determines a transmission destination of target data in the logical topology of the network having the terminals 200 as nodes. This allows shortening of a path length when target data is transmitted between the terminals 200 and allows a reduction in a communication load in the network 300.

Note that although the present disclosure has been described with reference to some example embodiments in conjunction with the accompanying drawings, those skilled in the art can easily make various modifications and alterations with regard to the disclosed example embodiments. It should thus be noted that such modifications and alterations are included in the scope of the present disclosure. For example, functions or the like included in units, means, operations, steps, and the like can be rearranged without logical contradiction, and a plurality of means, operations, steps, or the like may be combined into one or may be divided up. Components illustrated in the above-described example embodiments may be appropriately combined.

A communication system, a server and a non-transitory computer readable storage medium having stored therein a program according to the present disclosure can be utilized in a communication system which includes a server and a plurality of terminals and in which the server collects target data from the plurality of terminals and a program.

1. A communication system comprising a server and a plurality of terminals,
the server comprising first processing circuitry, the first processing circuitry configured to
manage a public key and a private key, with which information encrypted using the public key is decrypted; and
the plurality of terminals including a terminal and different terminals, the terminal including
a memory configured to store first target data, and
second processing circuitry configured to add noise to the first target data stored in the memory,
encrypt the first target data, to which the noise has been added, using the public key,
randomly choose and determine, out of the server and the different terminals, a first transmission destination of the first target data stored in the memory,
transmit the encrypted first target data to the determined first transmission destination,
receive second target data transmitted from one of the different terminals,
randomly choose and determine, out of the server and the different terminals, a second transmission destination of the received second target data, and
transmit the received second target data to the determined second transmission destination,
wherein the first processing circuitry of the server is further configured to
receive third target data from the terminals, and
decrypt the received third target data using the private key.

2. The communication system according to claim 1, wherein
the second processing circuitry is further configured to
randomly choose and determine, out of the different terminals, at least one of the first transmission destination or the second transmission destination,
randomly chooses and determines at least one of the first transmission destination or the second transmission destination, out of the different terminals, until a number of communications of a corresponding one of the first target data or the second target data between the terminals reaches a reference number of times, and
determine at least one of the first transmission destination or the second transmission destination to be the server after the number of data communications of a corresponding one of the first target data or the second target data between the terminals reaches the reference number of times.

3. The communication system according to claim 1, wherein
the second processing circuitry is further configured to randomly choose and determine, out of the different terminals, at least one of the first transmission destination or the second transmission destination,
randomly choose and determine at least one of the first transmission destination or the second transmission destination, out of the different terminals, until a number of data communications of a corresponding one of the first target data or the second target data between the terminals reaches a reference number of times, and
randomly chooses and determine at least one of the first transmission destination or the second transmission destination, out of the server and the different terminals, after the number of data communications times of a corresponding one of the first target data or the second target data between the terminals reaches the reference number of times.

4. The communication system according to claim 2, wherein
the reference number of times is determined in accordance with a number of the terminals.

5. The communication system according to claim 4, wherein
the reference number of times is determined in accordance with a value of a natural logarithm of the number of the terminals.

6. The communication system according to claim 1, wherein
the second processing circuitry is further configured to delete with a probability at least one of the first target data stored in the memory of the terminal or the received second target data.

7. The communication system according to claim 2, wherein
the second processing circuitry is further configured to delete at least one of the first target data or the second target data with a probability after the number of times of the data communications of the at least one of the first target data or the second target data between the terminals reaches the reference number of times.

8. The communication system according to claim 1, wherein
data communications between the terminals are performed via the server and at least one of the first target data or the second target data communicated through the data communications is end-to-end encrypted.

9. The communication system according to claim 1, wherein
the second processing circuitry is further configured to randomly choose and determines one of the different terminals as the first transmission destination of the first target data stored in the memory of the terminal, the one of the different terminals being a node adjacent to the terminal in a logical topology of a network that represents the terminals as nodes.

10. A server capable of communicating with a plurality of terminals,
the server comprising first processing circuitry, the first processing circuitry configured to
manage a public key and a private key, with which information encrypted using the public key is decrypted; and
the plurality of terminals including a terminal and different terminals, the terminal including
a memory configured to store first target data, and
second processing circuitry configured to
add noise to the first target data stored in the memory,
encrypt the first target data, to which the noise has been added, using the public key,
randomly choose and determine, out of the server and the different terminals, a first transmission destination of the first target data stored in the memory,
transmit the encrypted first target data to the determined first transmission destination,
receive second target data transmitted from one of the different terminals,
randomly choose and determine, out of the server and the different terminals, a second transmission destination of the received second target data, and
transmit the received second target data to the determined second transmission destination,
wherein the first processing circuitry of the server is further configured to
receive third target data from the terminals, and
decrypt the received third target data using the private key.

11. A non-transitory computer-readable storage medium having stored thereon a program which when executed by a terminal in a communication system including a server and a plurality of terminals, the terminal being one of the plurality of terminals, causes the terminal to:
add noise to first target data stored in a memory of the terminal;
encrypt the first target data, to which the noise has been added, using a public key managed by the server;
randomly choose and determine, out of the server and one or more different the terminals which are other than the terminal, a first transmission destination of the first target data stored in the memory of the terminal,
transmit the encrypted first target data to the determined first transmission destination;
receive second target data transmitted from a different terminal other than the terminal;
randomly choose and determine, out of the server and the one or more different terminals other than the terminal, a second transmission destination of the received second target data; and
transmit the received second target data to the determined second transmission destination.
